(19) United States
(12) Patent Application Publication
(10) Pub. No.: US 2024/0151601 A1
(43) Pub. Date: May 9, 2024

(54) ATMOSPHERIC-PRESSURE DETECTING SENSOR, ATMOSPHERIC-PRESSURE DETECTING DEVICE, AND METHOD FOR MANUFACTURING ATMOSPHERIC-PRESSURE DETECTING DEVICE

(71) Applicant: SEMITEC Corporation, Tokyo (JP)

(72) Inventors: Momoka YAMAZAKI, Tokyo (JP); Toshiyuki NOJIRI, Tokyo (JP)

(73) Assignee: SEMITEC Corporation, Tokyo (JP)

(21) Appl. No.: 18/281,309

(22) PCT Filed: Mar. 8, 2022
(86) PCT No.: PCT/JP2022/009979

§ 371 Date: Sep. 11, 2023

(30) Foreign Application Priority Data
Mar. 15, 2021 (JP) 2021-041313

(51) Int. Cl. G01L 11/00

(52) U.S. Cl. CPC G01L 11/002

(57) ABSTRACT

An atmospheric-pressure detecting sensor includes a thermistor for pressure detection and a thermistor for pressure compensation. The thermistor for pressure detection detects change in amount of heat loss in accordance with a thermal conductivity of an atmosphere. The thermistor for pressure compensation serves as a reference for pressure detection. At least resistance values of the thermistor for pressure detection and the thermistor for pressure compensation are paired as electrical characteristics and at least heat dissipation constants of the thermistor for pressure detection and the thermistor for pressure compensation are paired as thermal characteristics.

### TECHNICAL FIELD

The present invention relates to an atmospheric-pressure detecting sensor, an atmospheric-pressure detecting device, and a method for manufacturing an atmospheric-pressure detecting device.

### BACKGROUND ART

In the related art, for example, in production facilities for a thin-film formation process or the like, in order to manage and improve the product quality by controlling a vacuum environment such that it is brought into a suitable state, a thermal conduction vacuum gauge is used for measuring a vacuum pressure. There are a Pirani vacuum gauge and a thermistor vacuum gauge as total pressure gauges utilizing the pressure dependence of thermal conduction.

A Pirani vacuum gauge is a vacuum gauge for measuring a pressure by detecting temperature change in electrically heated thin metal wires of platinum or tungsten caused by thermal conduction of gas as change in electrical resistance thereof. Although it has a simple structure, stability and accuracy cannot be expected and it also has a problem of poor temporal responsiveness.

A thermistor vacuum gauge is a vacuum gauge using a semiconductor oxide thermistor having a large temperature coefficient of resistance instead of thin metal wires in a Pirani vacuum gauge. Bead-type thermistors were used in early thermistor vacuum gauges. Bead-type thermistors have significant variation in resistance value and also have variation in size, which lead to a problem in interchangeability. In addition, regarding thermistor vacuum gauges, various proposals have been made in order to improve sensitivity and accuracy (refer to Patent Literature 1 to Patent Literature 5).

### RELATED ART LITERATURE

### Patent Literature

Patent Literature 1: Japanese Examined Utility Model Application, Second Publication No. S38-8793
Patent Literature 2: Japanese Examined Utility Model Application, Second Publication No. S38-8794
Patent Literature 3: Japanese Patent No. 3124857
Patent Literature 4: Japanese Patent Application Laid-Open No. 2012-198187
Patent Literature 5: Japanese Patent No. 5764723

### SUMMARY OF INVENTION

### Problem to Be Solved by Invention

However, although various proposals have been made for a thermistor vacuum gauge, they are not satisfactory and further improvement in accuracy compared to those in the related art is expected.

An embodiment of the present invention has been made in consideration of the foregoing circumstances, and an object thereof is to provide an atmospheric-pressure detecting sensor, an atmospheric-pressure detecting device, and a method for manufacturing an atmospheric-pressure detecting device in which further improved accuracy can be expected. Furthermore, the atmospheric-pressure detecting sensor of the embodiment of the present invention can perform vacuum measurement and measurement of an atmospheric pressure higher than a barometric pressure.

### Means for Solving Problem

According to an embodiment of the present invention, there is provided an atmospheric-pressure detecting sensor including a thermistor for pressure detection that detects change in amount of heat loss in accordance with a thermal conductivity of an atmosphere, and a thermistor for pressure compensation that serves as a reference for pressure detection. At least resistance values of the thermistor for pressure detection and the thermistor for pressure compensation are paired as electrical characteristics and at least heat dissipation constants thereof are paired as thermal characteristics. Accordingly, improved accuracy can be expected.

According to another embodiment of the present invention, there is provided an atmospheric-pressure detecting device including the atmospheric-pressure detecting sensor which is bridge-connected to constitute a bridge circuit.

In addition, according to another embodiment of the present invention, there is provided a method for manufacturing an atmospheric-pressure detecting device which includes a thin-film thermistor for pressure detection that detects change in amount of heat loss in accordance with a thermal conductivity of an atmosphere and a thin-film thermistor for pressure compensation that serves as a reference for pressure detection, where at least resistance values of the thermistor for pressure detection and the thermistor for pressure compensation are paired as electrical characteristics and at least heat dissipation constants of the thermistor for pressure detection and the thermistor for pressure compensation are paired as thermal characteristics, and the atmospheric-pressure detecting device is bridge-connected to constitute a bridge circuit. The method for manufacturing an atmospheric-pressure detecting device includes an offset adjustment step of adjusting an output voltage of the atmospheric-pressure detecting device to zero under a barometric pressure.

### Effects of Invention

According to the embodiment of the present invention, it is possible to provide a vacuum detecting sensor in which accuracy can be improved, and an atmospheric-pressure detecting sensor, an atmospheric-pressure detecting device, and a method for manufacturing an atmospheric-pressure detecting device capable of measuring an atmospheric pressure higher than a barometric pressure.

In addition, since the atmospheric-pressure detecting sensor of the embodiment can measure an atmospheric pressure higher than a barometric pressure, it can be applied to sensors and wind-velocity detecting devices in which a wind velocity can also be detected by measuring a wind pressure.

### BRIEF DESCRIPTION OF DRAWINGS

FIG. 1 is a perspective view illustrating a thin-film thermistor according to an embodiment of the present invention.

FIG. 2 is a plan view illustrating a cross section of a base member in the same thin-film thermistor.

FIG. 3 is an enlarged plan view illustrating the same thin-film thermistor.

FIG. 4 is a cross-sectional view along line X-X in FIG. 3.

FIG. 5 is a perspective view illustrating the same atmospheric-pressure detecting sensor.

FIG. 6 is a plan view illustrating the same atmospheric-pressure detecting sensor.

FIG. 7 is a connection block diagram illustrating the same atmospheric-pressure detecting device.

FIG. 8 is a graph showing repetition reproducibility as output characteristics of the same atmospheric-pressure detecting device.

FIG. 9 is a graph showing output stability as output characteristics of the same atmospheric-pressure detecting device.

FIG. 10 is a graph showing a relationship between a pressure and an output voltage as output characteristics of the same atmospheric-pressure detecting device.

### DESCRIPTION OF EMBODIMENT

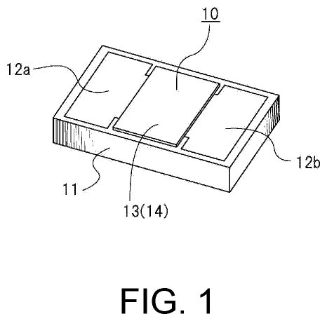

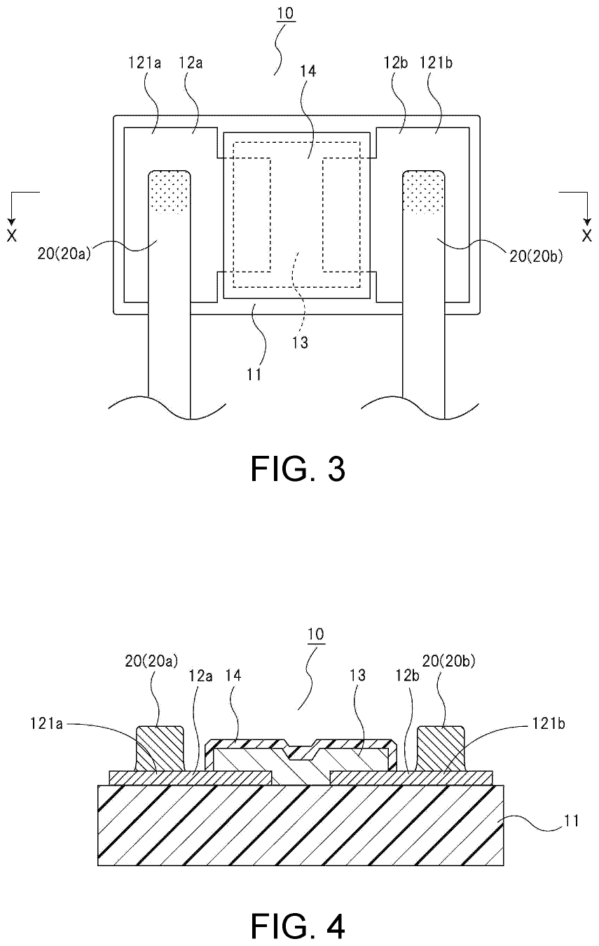

Hereinafter, an atmospheric-pressure detecting sensor and an atmospheric-pressure detecting device according to an embodiment of the present invention will be described with reference to FIGS. 1 to 10. In each of the diagrams, in order to make each member recognizable in size, the scales of the respective members may be suitably changed in the illustrations. In addition, the same reference signs are applied to parts which are the same or corresponding, and duplicate description is omitted.

The atmospheric-pressure detecting device of the present embodiment uses a thermal conduction-type atmospheric-pressure detecting sensor that detects a pressure of the atmosphere utilizing that a thermal conductivity of the atmosphere changes depending on the pressure. This atmospheric-pressure detecting sensor includes a thermistor for pressure detection and a thermistor for pressure compensation which are paired in regard to temperature characteristics and thermal characteristics, detecting change in heat dissipation state of the thermistor based on the thermal conductivity of the atmosphere and detecting this temperature change as a resistance change in the thermistor.

### [Atmospheric-Pressure Detecting Sensor]

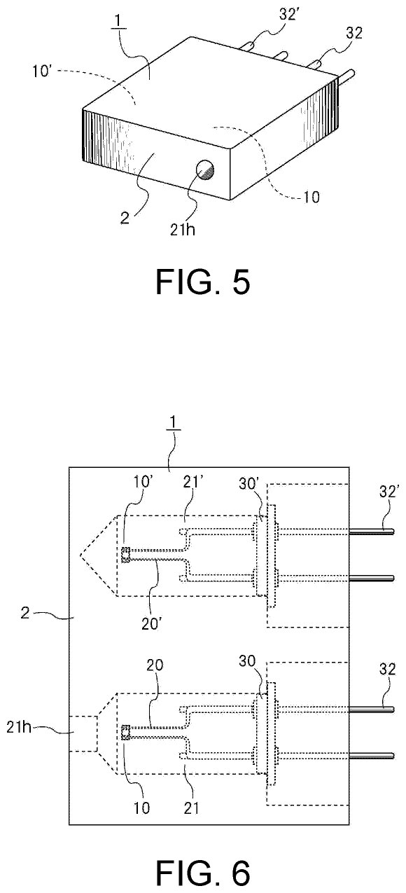

The atmospheric-pressure detecting sensor will be described with reference to FIGS. 1 to 6. FIGS. 1 to 4 illustrate a thin-film thermistor as a thermal resistance element, and FIGS. 5 and 6 illustrate an atmospheric-pressure detecting sensor.

First, as illustrated in FIGS. 5 and 6, an atmospheric-pressure detecting sensor 1 includes a pair of thermistors constituted of a thin-film thermistor 10 as a thermistor for pressure detection and a thin-film thermistor 10′ as a thermistor for pressure compensation serving as a reference for pressure detection, and a case 2 having substantially a rectangular parallelepiped shape in which the thin-film thermistor 10 for pressure detection and the thin-film thermistor 10′ for pressure compensation are accommodated. The thin-film thermistor 10 for pressure detection and the thin-film thermistor 10′ for pressure compensation are thermal resistance elements having substantially equivalent characteristics and paired with high accuracy as described below.

Next, the thin-film thermistor 10 for pressure detection will be described with reference to FIG. 1. Since the thin-film thermistor 10 for pressure detection and the thin-film thermistor 10′ for pressure compensation basically have the same constitution, the thin-film thermistor 10 for pressure detection will be representatively described.

The thin-film thermistor 10 for pressure detection is a surface mounting type and has an insulating substrate 11, a pair of electrode layers 12a and 12b as electrode parts, a heat detecting film 13, and a protective film 14. In addition, the thin-film thermistor 10 is formed to have substantially a rectangular parallelepiped shape and preferably has a substrate thickness dimension of 200 μm or smaller and a size with a horizontal dimension of 1 mm and a vertical dimension 0.5 mm or larger. Accordingly, it can be thin and miniaturized while a predetermined surface area is ensured.

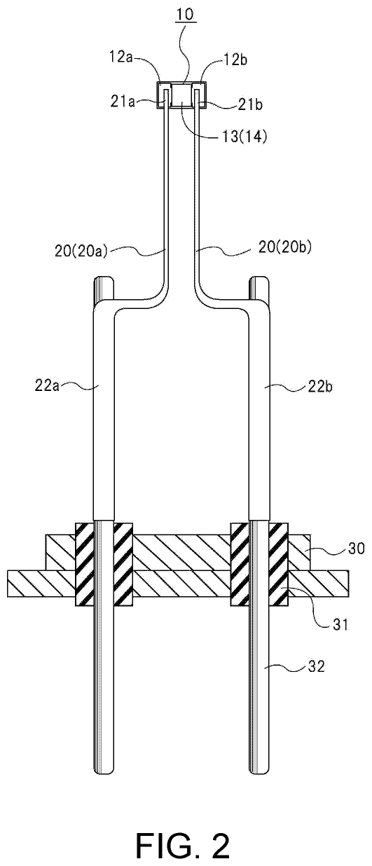

As illustrated in FIGS. 2 to 4, lead members 20 are connected to the thin-film thermistor 10, and the lead members 20 are connected to a base member 30.

The insulating substrate 11 has substantially a rectangular shape and is formed using a ceramic material such as insulating zirconia, silicon nitride, alumina, or a mixture of at least one kind of these. This insulating substrate 11 is formed to be thin such that the thickness dimension is 200 μm or smaller and is more preferably 100 μm or smaller. In addition, the insulating substrate 11 has a bending strength of 690 MPa or higher, and the average particle size after burning of a ceramic material is 0.1 μm to 2 μm. A bending strength of 690 MPa or higher can be ensured by setting the range of the average particle size in this manner, and thus cracking can be curbed when the thin insulating substrate 11 is produced. In addition, since the insulating substrate 11 has a small thickness dimension, a heat capacity can be reduced.

The pair of electrode layers 12a and 12b are formed on the insulating substrate 11, in which the heat detecting film 13 is an electrically connected portion, and they are disposed in a manner of facing each other with a predetermined interval therebetween. Specifically, the pair of electrode layers 12a and 12b are formed by forming a metal thin film with a thickness dimension of 1 μm or smaller using a thin-film formation technology such as a sputtering method, and a precious metal such as gold (Au), silver (Ag), copper (Cu), platinum (Pt), or palladium (Pd), or an alloy of these, for example, a Ag—Pd alloy or the like is applied as a metal material thereof.

The pair of electrode layers 12a and 12b are portions to which the lead members 20 (which will be described below) are bonded by welding, and it is preferable to use, as a low-melting point metal, gold (Au: melting point of 1,064° C.), silver (Ag: melting point of 961° C.), copper (Cu: melting point of 1,085° C.), or an alloy including at least one kind of these as a main component. In addition, in the present embodiment, the electrode layers 12a and 12b are formed under the heat detecting film 13 but they may be formed on or inside the heat detecting film 13.

The heat detecting film 13 is a thermosensitive thin film and is a thin film of a thermistor constituted of an oxide semiconductor having a negative temperature coefficient. The heat detecting film 13 is formed on the electrode layers 12a and 12b in a manner of straddling the electrode layers 12a and 12b by performing film formation using a thin-film formation technology such as a sputtering method and is electrically connected to the electrode layers 12a and 12b.

The heat detecting film 13 consists of two or more kinds of elements selected from transition metal elements such as manganese (Mn), nickel (Ni), cobalt (Co), and iron (Fe) and consists of a thermistor material including composite metal oxide having a spinel crystal structure as a main component. In addition, an accessory component may be contained in order to improve characteristics and the like. The compositions and the contents of a main component and an accessory component can be suitably determined in accordance with desired characteristics.

The protective film 14 covers a region in which the heat detecting film 13 is formed and covers the electrode layers 12a and 12b with exposed parts 121a and 121b formed to expose at least a portion of the electrode layers 12a and 12b. The protective film 14 is formed by performing film formation of silicon dioxide, silicon nitride, or the like using a thin-film formation technology such as a sputtering method or can be formed of a lead glass, a borosilicate glass, lead borosilicate glass, or the like by a printing method.

A pair of lead members 20a and 20b are bonded and electrically connected to the thin-film thermistor 10 described above in a welded state. The lead members 20a and 20b are elastic bodies having elasticity and formed by means such as chemical etching or pressing, are thin narrow metal plates having a plate shape, and are lead frames. In addition, the lead members 20a and 20b have a thickness dimension of 100 μm or smaller or preferably approximately 30 μm, and a width dimension is 80 μm to 200 μm. In addition, a material having a thermal conductivity of 50 W/m·K or lower is used.

Specifically, for the lead members 20, for example, a low thermal conductivity constantan having a thermal conductivity of 19.5 W/m·K is used. A material such as HASTELLOY (registered trademark) may be used as a material having a low thermal conductivity.

These lead members 20a and 20b are connected to the electrode layers 12a and 12b in a welded state by laser welding. Therefore, metals of the electrode layers 12a and 12b and the lead members 20a and 20b melt and are bonded to each other. For this reason, since there is no additional material, such as a filler material (brazing material) used in a case of soldering or the like, between the electrode layers 12a and 12b and the lead members 20a and 20b, that is, there is no inclusion therebetween, the heat capacity can be reduced, the thermal time constant can be reduced, and the thermal responsiveness of the thin-film thermistor 10 can be quickened.

In this manner, by selecting a weldable material having a thermal conductivity of 50 W/m·K or lower for the lead members 20, the heat capacity and the heat dissipation constant of the thin-film thermistor 10 by the lead members 20 can be reduced. In addition to the fact that the thin-film thermistor 10 is thin and miniaturized, the thin-film thermistor 10 having high sensitivity and excellent thermal responsiveness can be realized.

Specifically, the lead members 20a and 20b are formed to respectively have bonded parts 21a and 21b and lead parts 22a and 22b integrally extending from these bonded parts 21a and 21b. The bonded parts 21a and 21b are portions bonded to the electrode layers 12a and 12b of the thermosensitive element 10 by welding and are disposed in a direction orthogonal to the direction in which the electrode layer 12a and the electrode layer 12b are disposed side by side. The lead parts 22a and 22b are bent to the outward side from the bonded parts 21a and 21b and extend in a direction parallel to the bonded parts 21a and 21b. The bonded parts 21a and 21b bonded to the electrode layers 12a and 12b of the thin-film thermistor 10 are formed to have a width dimension narrower than the width dimensions of the lead parts 22a and 22b. The thin-film thermistor 10 is bonded to tip parts of the bonded parts 21a and 21b and is connected thereto in a crosslinked shape.

The lead members 20a and 20b are formed of a low-melting point metal, that is, a metal having a melting point of 1,300° C. or lower, and for example, a copper alloy including copper such as a constantan, HASTELLOY (registered trademark), or manganin as a main component is used. In the present embodiment, specifically, as described above, a material of constantan is used.

When the electrode layers 12a and 12b of the thin-film thermistor 10 and the lead members 20a and 20b are bonded to each other by laser welding, for example, since the melting points of the lead members 20a and 20b are 1,300° C. or lower, even if they are heated and melted using a laser beam or the like, the temperature thereof does not become 1,300° C. or higher (melting point). Therefore, since the temperature does not exceed 1,600° C. to 2,100° C. that is the melting point of a ceramic substrate, the lead members 20a and 20b can be bonded while damage to the electrode layers 12a and 12b of the thermosensitive element 10 or the insulating substrate 11 immediately below the electrode layers 12a and 12b is curbed. In addition, in this case, since no additional material such as a bump is used, high sensitivity and prompt thermal responsiveness can be achieved without being bonded to a connection (bonding) place in a state of having an additional material practically added thereto, without having a large thickness dimension, and without increasing the heat capacity.

In the related art, an iron-based metal such as stainless steel, Kovar, or a nickel alloy is used for the lead members described above. Since this iron-based metal has a high melting point, for example, both stainless steel and Kovar are iron-based alloys, the temperature may rise to approximately 1,538° C. that is the melting point of iron. If such lead members made of a high-melting point metal are irradiated with a laser beam for laser welding, the lead members and a surround area thereof are heated to a high temperature, which causes a problem that the insulating substrate (for example, alumina substrate) is likely to be damaged. In addition, solder bonding has a problem that a heat-resistance temperature in consideration of a temperature cycle becomes 150° C. or lower and heat resistance of 200° C. or higher cannot be ensured.

According to the foregoing constitution of the present embodiment, heat resistance of 200° C. or higher can be ensured, and such problems can be resolved. In addition, since an additional material or a solder filler material (brazing material) is not interposed between the electrode layers 12a and 12b and the lead members 20a and 20b as an inclusion, there is no quantitative variation caused by this inclusion, and thus variation in output characteristics of individual thin-film thermistors can be curbed.

As representatively illustrated in FIG. 2, the base member 30 is a metal member formed to have substantially a disk shape, and conductive terminal parts 32 are inserted therethrough with insulating members 31 therebetween. The lead members 20a and 20b derived from the thin-film thermistor 10 are electrically connected to the conductive terminal parts 32 by welding. The insulating members 31 are formed of an insulating material such as a glass or a resin.

When the base member 30 is formed of an insulating material, the insulating members 31 can be omitted. In addition, the conductive terminal parts 32 may be constituted of a printed wiring substrate or the like.

As illustrated in FIGS. 5 and 6, in the atmospheric-pressure detecting sensor 1, the thin-film thermistor 10 for pressure detection and the thin-film thermistor 10′ for pressure compensation having substantially equivalent characteristics and paired with high accuracy are accommodated inside the case 2.

The case 2 has substantially a rectangular parallelepiped external shape, and a pair of accommodation space parts 21 and 21′ having a tapered cylindrical shape are formed in a divided manner. The case 2 preferably has a thermal conductivity of 80 W/m·K or higher. For example, it is made of aluminum, and a constant temperature is maintained inside the case 2 by curbing an influence of fluctuation in ambient temperature. In order to adjust the temperature of the case 2 to be constant, for example, the case 2 may be heated using temperature adjustment means such as a heater. In this case, an influence of fluctuation in ambient temperature can be further curbed.

The thin-film thermistor 10 for pressure detection is accommodated in the accommodation space part 21. A penetration hole 21a opening to the outward side is formed on a distal end side of the accommodation space part 21, and this accommodation space part 21 is in a state of communicating with outside air (atmosphere) through the penetration hole 21a. Therefore, the thin-film thermistor 10 for pressure detection is in a state of being affected by outside air.

On the other, the thin-film thermistor 10′ for pressure compensation is accommodated in the accommodation space part 21′ under a constant atmospheric pressure, specifically under a barometric pressure in a sealed state. Accordingly, the thin-film thermistor 10 for pressure detection is in a state of not being affected by outside air (atmosphere).

In this manner, the thin-film thermistor 10 for pressure detection and the thin-film thermistor 10′ for pressure compensation are accommodated in the case 2 having the same shape, specifically, accommodated in the case 2 in which the accommodation space part 21 and the accommodation space part 21′ or forms of circumferential walls are substantially the same. The penetration hole 21a of the accommodation space part 21 is formed to have smaller diameter than an inner diameter of the accommodation space part 21. For this reason, there is no significant difference between volumes of the accommodation space part 21 and the accommodation space part 21′. Therefore, the thin-film thermistor 10 for pressure detection and the thin-film thermistor 10′ for pressure compensation are in substantially the same thermal environment, a difference between thermal influences of both can be reduced, and variation in heat dissipation constants of the thin-film thermistor 10 for pressure detection and the thin-film thermistor 10′ for pressure compensation including radiant heat from inner circumferential walls of the accommodation space part 21 and the accommodation space part 21′ can be reduced. Conductive terminal parts 32 and 32′ are derived from a rear end side of the case 2. Cases accommodating the thin-film thermistor 10 for pressure detection and the thin-film thermistor 10′ for pressure compensation may be separately constituted such that substantially the same thermal environment is formed.

(Pairing)

Pairing of the thin-film thermistor 10 for pressure detection and the thin-film thermistor 10′ for pressure compensation will be described.

Characteristics of the thermistors are basically determined based on a resistance value (zero load resistance value at 25° C.), a B constant, a heat dissipation constant, and a thermal time constant. In addition, the resistance value and the B constant can be ascertained as electrical characteristics, and the heat dissipation constant and the thermal time constant can be ascertained as thermal characteristics.

Regarding a relationship between the thin-film thermistor 10 for pressure detection and the thin-film thermistor 10′ for pressure compensation, it is ideal that characteristic values thereof completely coincide with each other, but it is difficult for them to completely coincide with each other. Therefore, it is important to realize pairing within a highly accurate variation range of the characteristic values.

Generally, variation (allowable difference) in resistance value of thermistors of these kinds is ±5%, variation in B constant is ±3%, and variation in heat dissipation constant is approximately ±10%. Furthermore, in consideration of variation in power source and the like, the accuracy of the atmospheric-pressure detecting sensor becomes ±20%.

In the present embodiment, regarding pairing of the characteristic values of the thin-film thermistor 10 for pressure detection and the thin-film thermistor 10′ for pressure compensation, the resistance value as the electrical characteristics is ±0.2% or lower, and the B constant also has the accuracy of ±0.2% or lower. In addition, the heat dissipation constant as the thermal characteristics is also ±0.2% or lower.

Incidentally, regarding processing means for realizing such highly accurate pairing, when variation in resistance value is corrected, a trimming method of cutting electrode surfaces of the thin-film thermistors or a portion of main bodies of the thin-film thermistors by laser irradiation or a sandblasting method is applied. In addition, when variation in heat dissipation constant is corrected, processing means such as uniformizing the thicknesses of the insulating substrates of the thin-film thermistors and the dicing sizes when the thin-film thermistors are cut from the same wafer, making the case in the same shape to have substantially the same thermal environment, and bonding the lead members by welding are suitably applied. In addition, means for sorting the produced thin-film thermistors may be applied.

Subsequently, indices for pairing the thin-film thermistor 10 for pressure detection and the thin-film thermistor 10′ for pressure compensation with high accuracy will be described. Values of variation in allowable characteristics are derived.

Eight samples of thin-film thermistors (elements No. 1 to No. 8) subjected to pairing processing means were prepared. In the elements No. 1 to No. 8, resistance values (Ku) at 25° C., resistance values (Ku) at 85° C., and measurement calculation values of heat dissipation constants (mw/° C.) were obtained, and the average value, the largest value, the smallest value, and the variation value of the resistance values at 25° C., the resistance values at 85° C., and the heat dissipation constants were calculated.

Regarding quality management of a step of manufacturing a thermistor of this kind, the accuracy of a resistance value (allowable difference) of a bead-type thermistor is approximately ±15%, the heat dissipation constant serves as a reference value, and the accuracy thereof is not managed at present. On the other, the accuracy of a resistance value of a thin-film thermistor is approximately ±5%, the heat dissipation constant serves as a reference value similar to a bead-type thermistor, and the accuracy thereof is in an unmanaged state. There is no method for accurately measuring a heat dissipation constant, resulting in such circumstances. The inventors have focused on the heat dissipation constant, have established a technology of measuring a heat dissipation constant with high accuracy, and have applied it to the present invention.

If a thermistor having accuracy of a resistance value of approximately ±15% is used, accuracy of ±15% or lower cannot be realized as the accuracy of the atmospheric-pressure detecting sensor. On the other, if the heat dissipation constant is approximately ±15%, accuracy of ±15% or lower cannot be realized as the accuracy of the atmospheric-pressure detecting sensor. The accuracy of thermal conduction-type vacuum sensors which are currently available on the market is ±15% to ±50%.

The results of examinations and experiments performed based on those above have led to a conclusion that high accuracy can be realized by precisely controlling variation in resistance value to ±1% or lower and variation in heat dissipation constant to ±1% or lower in order to achieve higher accuracy than the thermal conduction types in the related art. The expression “in resistance value to ±1% or lower” indicates an allowable difference based on the average value of the resistance values of the thin-film thermistor 10 for pressure detection and the thin-film thermistor 10′ for pressure compensation. The same applies to the heat dissipation constant as well. Therefore, specifically, pairing of the resistance value and the heat dissipation constant is performed by management and manufacturing with a predetermined allowable difference.

Thus, in the thin-film thermistor 10 for pressure detection and the thin-film thermistor 10′ for pressure compensation, the measurement accuracy can be improved by pairing at least the resistance values as the electrical characteristics and pairing at least the heat dissipation constants as the thermal characteristics.

### [Atmospheric-Pressure Detecting Device]

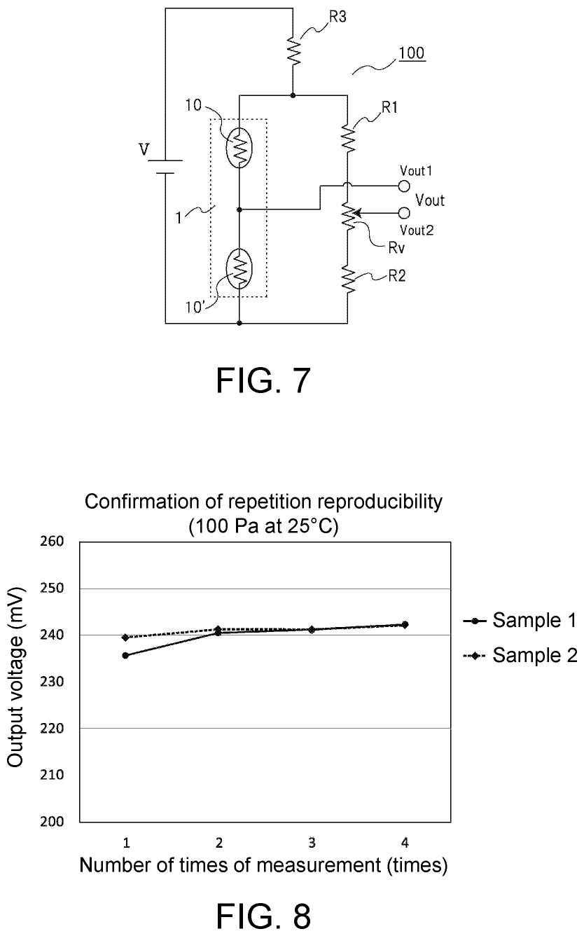

As illustrated in FIG. 7, in an atmospheric-pressure detecting device 100, a power source V is connected to the atmospheric-pressure detecting sensor 1, thereby constituting a bridge circuit. A differential output between output voltages Vout₁ and Vout₂ can be detected as an output voltage Vout.

A series circuit of the thin-film thermistor 10 for pressure detection and the thin-film thermistor 10′ for pressure compensation and a series circuit of a fixed resistor R₁, a variable resistor R_{V}, and a fixed resistor R₂ are connected in series with respect to the power source V through a limiting resistor R₃. In addition, an output terminal is connected to an intermediate portion of each series circuit, and a potential difference at the intermediate point between the output voltages Vout₁ and Vout₂ can be detected as the output voltage Vout.

A bridge circuit may be constituted by connecting the thin-film thermistor 10 for pressure detection and the thin-film thermistor 10′ for pressure compensation in parallel. In this case, the series circuit of the fixed resistor R₁ and the thin-film thermistor 10 for pressure detection, and the fixed resistor R₂, the variable resistor R_{V}, and the thin-film thermistor 10′ for pressure compensation are connected in parallel with respect to the power source V through the limiting resistor R₃. Further, the output terminal is connected to the intermediate portion of each series circuit, and a potential difference at the intermediate point between the output voltages Vout₁ and Vout₂ can be detected as the output voltage Vout. When vibration or the like becomes a problem, a fixed resistor can be constituted to be combined without using a variable resistor.

In addition, in manufacturing (production) of the atmospheric-pressure detecting device 100, an offset adjustment step of adjusting an offset voltage of the output voltages Vout₁ and Vout₂ to zero under a barometric pressure. Specifically, a potential difference between the output voltages Vout₁ and Vout₂ is adjusted to zero by adjusting the resistance value of the variable resistor R_{V}. Since the thin-film thermistor 10′ for pressure compensation is accommodated in the case 2 in a sealed state under a barometric pressure, offset adjustment can be easily performed with high accuracy.

Subsequently, with reference to FIG. 7, an outline of operation of the atmospheric-pressure detecting device 100 will be described. First, the atmospheric-pressure detecting sensor 1 is disposed in the atmosphere to be measured. When the atmospheric-pressure detecting device 100 is driven, the thin-film thermistor 10 for pressure detection detects change in heat dissipation state, that is, change in amount of heat loss based on the thermal conductivity of the atmosphere to be measured and detects this temperature change as a resistance change. A potential difference at the intermediate point between the output voltages Vout₁ and Vout₂ is detected as the output voltage Vout based on the thin-film thermistor 10′ for pressure compensation. Since the thermal conductivity of the atmosphere depends on the pressure, the pressure of the atmosphere to be measured can be detected based on the output voltage Vout.

The output voltage Vout is input to control processing means such as a microcomputer (not illustrated) and subjected to arithmetic processing, and the pressure of the atmosphere to be measured is output as a detection output. The thin-film thermistor 10 for pressure detection and the thin-film thermistor 10′ for pressure compensation is controlled such that a self-heating temperature becomes 200° C. or lower in order to ensure the heat resistance.

### [Output Characteristics]

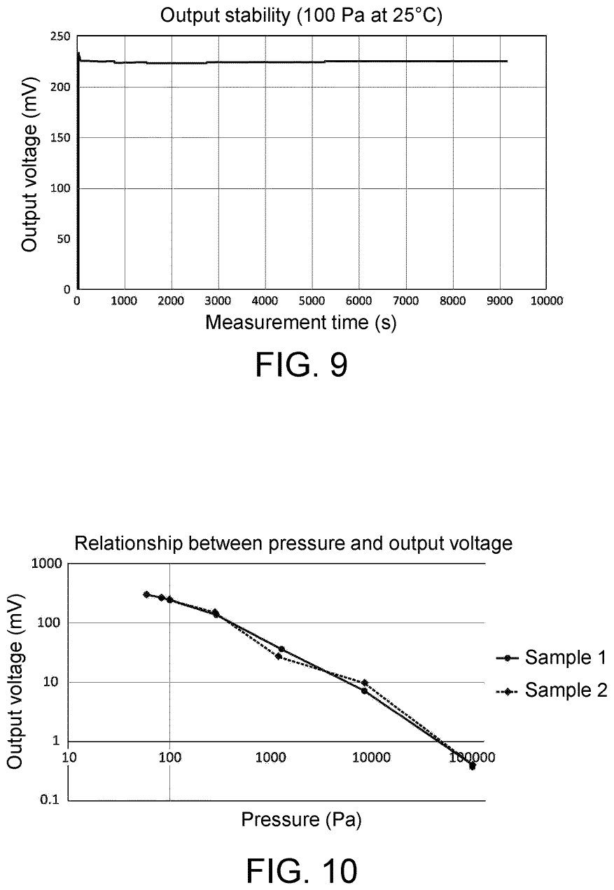

Output characteristics by the atmospheric-pressure detecting device 100 of the foregoing embodiment will be described with reference to FIGS. 8 to 10. FIG. 8 is a graph showing confirmed results of repetition reproducibility, FIG. 9 is a graph showing output stability, and FIG. 10 is a graph showing a relationship between a pressure and an output voltage.

(Repetition Reproducibility)

In FIG. 8, Sample 1 and Sample 2 of two atmospheric-pressure detecting devices were prepared, and repetition reproducibility was measured. The horizontal axis indicates the number of times of measurement (times), and the vertical axis indicates the output voltage (mV). The ambient temperature was 25° C., and the atmospheric pressure of the atmosphere to be measured was 100 Pa which was the same condition. However, the atmosphere to be measured divided into first to fourth measurement was varied.

As illustrated in the diagram, in the first measurement, the difference between the output voltages of Sample 1 and Sample 2 remained approximately ±1.4%, and in the second to fourth measurement thereafter, the output voltage was 240 mV which was substantially constant. Therefore, it is understood that the repetition reproducibility is favorable.

(Output Stability)

In FIG. 9, the output stability of the atmospheric-pressure detecting device was measured. The horizontal axis indicates the time (s), and the vertical axis indicates the output voltage (mV). The ambient temperature was 25° C. and the atmospheric pressure of the atmosphere to be measured was 100 Pa, as a condition.

As illustrated in the diagram, it is understood that the output voltage scarcely changes in the range of 60 seconds to 9,000 seconds, which is extremely stable.

(Relationship Between Pressure and Output Voltage)

In FIG. 10, Sample 1 and Sample 2 of two atmospheric-pressure detecting devices were prepared, and a relationship between the pressure and the output voltage was measured. The horizontal axis indicates the pressure (Pa), and the vertical axis indicates the output voltage (mV).

As illustrated in the diagram, it is understood that there is little variation in output voltage over a wide range of 60 Pa to 100,000 Pa. Particularly, in the range of 60 Pa to 300 Pa, results of the output voltages which substantially coincided with each other and very little variation were obtained. On the other, in the case of the absolute pressure of 0.2 MPa which was a pressure higher than the absolute pressure of the barometric pressure of 0.1 MPa, it was confirmed that the sign changed and an output of approximately −4 mV was obtained.

It is conceivable that such output characteristics are obtained due to the thin-film thermistor 10 for pressure detection and the thin-film thermistor 10′ for pressure compensation which are paired with high accuracy.

As described above, according to the present embodiment, it is possible to provide the atmospheric-pressure detecting sensor 1, the atmospheric-pressure detecting device 100, and the method for manufacturing an atmospheric-pressure detecting device in which sensitivity and accuracy can be improved.

Specifically, since thin-film thermistors are used for pressure detection and pressure compensation, the surface area can be increased compared to bead-type thermistors in the related art. In addition, since a material having a low thermal conductivity of which the thermal conductivity is 50 W/mK or lower is used for the lead members 20a and 20b, the heat dissipation constant can be reduced and the sensitivity can be improved.

In addition, since the thin-film thermistor 10 for pressure detection and the thin-film thermistor 10′ for pressure compensation are paired with high accuracy, the measurement accuracy can be improved and variation in the individual atmospheric-pressure detecting sensor 1 can be reduced. It is conceivable that this is mainly because variation in heat dissipation constant can be reduced due to the thin-film thermistor 10 for pressure detection and the thin-film thermistor 10′ for pressure compensation arranged in substantially the same thermal environment in the case 2 having the same shape and the lead members 20a and 20b bonded to the thin-film thermistor 10 for pressure detection and the thin-film thermistor 10′ for pressure compensation by welding.

In the foregoing embodiment, a case in which the lead members 20a and 20b are connected to the electrode layers 12a and 12b has been described. However, in the case of a constitution in which a wiring pattern is additionally connected to the electrode layers, a material having a low thermal conductivity may be used for the wiring pattern and lead members may be bonded to this wiring pattern.

The present invention is not limited to the constitution of the foregoing embodiment, and various modifications can be made within a range not departing from the gist of the invention. In addition, the foregoing embodiment has been presented as an example and is not intended to limit the scope of the invention. These novel embodiments can be performed in various other forms, and various omissions, replacements, and changes can be made. These embodiments and modifications thereof are included in the scope and the gist of the invention and are included in the invention described in the claims and the scope equivalent thereto. Reference Signs List
1 Atmospheric-pressure detecting sensor
2 Case
10 Thin-film thermistor for pressure detection
10′ Thin-film thermistor for pressure compensation
11 Insulating substrate
12a, 12b Electrode layer
13 Heat detecting film
14 Protective film
20 Lead member
21 Accommodation space part
21a Penetration hole
22a Electrode part
22b Lead part
30 Base member
32 Conductive terminal part
100 Atmospheric-pressure detecting device

1. An atmospheric-pressure detecting sensor comprising:
a thermistor for pressure detection that detects change in amount of heat loss in accordance with a thermal conductivity of an atmosphere; and
a thermistor for pressure compensation that serves as a reference for pressure detection,
wherein at least resistance values of the thermistor for pressure detection and the thermistor for pressure compensation are paired as electrical characteristics and at least heat dissipation constants of the thermistor for pressure detection and the thermistor for pressure compensation are paired as thermal characteristics.

2. The atmospheric-pressure detecting sensor according to claim 1,
wherein the thermistor for pressure detection and the thermistor for pressure compensation are thin-film thermistors.

3. The atmospheric-pressure detecting sensor according to claim 1,
wherein the thermistor for pressure detection and the thermistor for pressure compensation are individually accommodated in a case having divided accommodation space parts and are arranged in substantially the same thermal environment.

4. The atmospheric-pressure detecting sensor according to claim 3,
wherein the accommodation space part accommodating the thermistor for pressure detection is in a state of communicating with outside air, and the accommodation space part accommodating the thermistor for pressure compensation is in a sealed state under a constant atmospheric pressure.

5. The atmospheric-pressure detecting sensor according to claim 1,
wherein a lead member is connected to an electrode layer of each of the thermistor for pressure detection and the thermistor for pressure compensation in a welded state.

6. The atmospheric-pressure detecting sensor according to claim 5,
wherein the lead member has a thermal conductivity of 50 W/m·K or lower.

7. The atmospheric-pressure detecting sensor according to claim 1,
wherein pairing of the resistance values is at ±1% or lower.

8. The atmospheric-pressure detecting sensor according to claim 1,
wherein pairing of the heat dissipation constants is at ±1% or lower.

9. The atmospheric-pressure detecting sensor according to claim 2,
wherein a substrate of each of the thermistor for pressure detection and the thermistor for pressure compensation has a thickness dimension of 200 μm or smaller and has a size with a horizontal dimension of 1 mm and a vertical dimension of 0.5 mm or larger.

10. The atmospheric-pressure detecting sensor according to claim 3,
wherein the case is constituted such that a temperature of the case is adjusted to be constant.

11. An atmospheric-pressure detecting device comprising:
the atmospheric-pressure detecting sensor according to claim 1 which is bridge-connected to constitute a bridge circuit.

12. The atmospheric-pressure detecting device according to claim 11,
wherein an output voltage of the bridge circuit is adjusted to zero under a barometric pressure.

13. The atmospheric-pressure detecting device according to claim 11,
wherein the thermistor for pressure detection and the thermistor for pressure compensation in the atmospheric-pressure detecting sensor are controlled such that self-heating temperatures become 200° C. or lower.

14. A method for manufacturing an atmospheric-pressure detecting device which includes a thermistor for pressure detection that detects change in amount of heat loss in accordance with a thermal conductivity of an atmosphere and a thermistor for pressure compensation that serves as a reference for pressure detection, wherein at least resistance values of the thermistor for pressure detection and the thermistor for pressure compensation are paired as electrical characteristics and at least heat dissipation constants of the thermistor for pressure detection and the thermistor for pressure compensation are paired as thermal characteristics, and the atmospheric-pressure detecting device is bridge-connected to constitute a bridge circuit, the method for manufacturing an atmospheric-pressure detecting device comprising:
an offset adjustment step of adjusting an output voltage of the atmospheric-pressure detecting device to zero under a barometric pressure.
